(19) United States
(12) Patent Application Publication
(10) Pub. No.: US 2005/0180356 A1
(43) Pub. Date: Aug. 18, 2005

(54) Multi-channel wireless broadcast protocol for a self-organizing network

(75) Inventors: Donald W. Gillies, La Jolla, CA (US); Weilin Wang, La Jolla, CA (US)

Correspondence Address: CATALYST LAW GROUP, APC, 9710 SCRANTON ROAD, SUITE S-170, SAN DIEGO, CA, 92121, US

(73) Assignee: Graviton, Inc.

(21) Appl. No.: 10/316,621

(22) Filed: Dec. 10, 2002

Related U.S. Application Data
(60) Provisional application No. 60/415,056, filed on Oct. 1, 2002.

(51) Int. Cl. H04Q 7/00; H04L 12/413

(52) U.S. Cl. 370/329; 370/445

(57) ABSTRACT

The disclosed embodiments of a media access control (MAC) scheme are devised to solve the hidden node problem for channel-hopping broadcast operations in wireless communication networks. The multi-channel broadcast MAC may be adapted to sense and hop around channel interference, and to perform concurrent sensing and load balancing across a set of channels. A multi-hop routing engine using this packet broadcast operator may allow a plurality of network nodes to organize themselves reliably into a communications network. By routing packets around the troubled areas, the routing engine may heal nodal and link failures. When a node changes location, the routing engine may reorganize the network topology automatically and restore the connectivity between communicating peers.

### BACKGROUND INFORMATION

1. Field of the Invention

The present invention relates generally to wireless networks and, more particularly, to a protocol for facilitating communication in a self-organizing, wireless network.

2. Background

The information contained in this section relates to the background of the art of the present-invention without any admission as to whether or not it legally constitutes prior art.

Wireless networks that are often referred to as ad hoc networks typically lack a fixed, pre-existing infrastructure such as base stations and access points. Thus, these networks typically lack the rigid master (clocker) and slave (clock follower) relationships present in other networks. A network wherein any node can provide the communications clock is referred to as a “peer-to-peer” network.

Further, many of these ad hoc networks operate in the unlicensed radio frequency bands, resulting in the potential of interference with other networks.

Following the IEEE 802 network convention, the Data Link Layer of the OSI Reference Model is divided into two sublayers: the Logical Link Control (LLC) layer and the Media Access Control (MAC) layer. The MAC layer interfaces directly with the network media.

Many MACs that appear in radio systems lack important features to support direct peer-to-peer communication. One problem with broadcasting on a particular channel is that every node in the network must listen to the same channel at the same time.

On the other hand, it may be desirable to hop among many channels and avoid interference with a peer-to-peer MAC. Peer-to-peer MACs that require exhaustive scanning of a large set of channels typically have low data throughput.

Peer-to-peer MACs that rely upon a single channel are unreliable when there is channel contention (such as that from microwave ovens, or from IEEE 802.11b wireless systems or cordless phones.)

No practical solutions to the problems of a multi-channel broadcast peer-to-peer MAC have appeared in the literature. As a result, existing MACs typically use a single channel or a single hopping sequence in the case of a frequency-hopping network, such as a network operating under the Bluetooth protocol. For further information on the Bluetooth protocol, reference may be made to http://www.bluetooth.com/pdf/Bluetooth_{—}11_Specifications_Book.pdf.

Another problem in broadcasting is that known as the “hidden node” problem. The “hidden node” problem refers to a scenario in which packet collisions may occur when two transmitting nodes are unaware of each other. For example, node X may want to send a packet to node Y, and node Z may also want to send a packet to node Y. Node Z and node X may be too far apart to be able to detect each other. This may cause a packet collision at node Y. If this is a problem for unicast messages, it is even more of a problem for broadcast messages, because broadcast packets are often used to “flood” a network.

No practical solutions to the hidden node problem for wireless broadcasts have appeared in the literature. As a result, broadcast transmissions are always less reliable than unicast transmissions in wireless networks. In a CSMA/CD Ethernet network, broadcast transmissions are exactly as reliable as unicast transmissions. Therefore, any wireless self-organizing routing system that relies on broadcast capability to maintain network connectivity and routing information is inherently less reliable than a wired routing system such as Ethernet

### SUMMARY OF THE INVENTION

The disclosed embodiments described herein overcome the foregoing problems. The disclosed embodiments of the present invention include a multi-hop routing architecture to configure an ad hoc network automatically and to transport data. A node in the network is capable of sending and receiving control data and payload. A self-organizing capability allows a network to adapt to the changing network topology and RF reception conditions, for example, and to reconfigure itself dynamically to route packets around troubled areas. It also allows a network to expand an existing installation easily and reliably without relocating any existing “hub” nodes. In addition, disclosed embodiments of a multi-hop network save power and extends the reach of a network, without adding expensive wires or amplifiers.

The disclosed embodiments of the multi-channel broadcast MAC described herein have a reliable broadcast mechanism that solves the hidden node problem and channel-hops when necessary. A multi-hop, ad hoc routing network can thus be constructed reliably and with greater bandwidth efficiency using this broadcast paradigm. Specifically, the disclosed embodiments of the multi-channel broadcast MAC resolves the problems encountered in wireless communications, including hidden and exposed node, collision during mastering of a channel, channel contention bottlenecks in peer-to-peer communications, interference or jamming on a broadcast channel, and low-duty cycle communications to prolong battery life.

The disclosed embodiments include a multi-channel peer-to-peer broadcast MAC that supports multiple channel masters. The disclosed embodiments of the MAC have a reliable broadcast that solves the hidden node problem and channel-hop around interference.

When transporting unicast messages, certain disclosed embodiments of the MAC perform “Area Load Balancing” (ALB) to balance wireless throughput in a geographic area, for example. The disclosed MACs may carry packets of arbitrary size. Disclosed embodiments of a multi-hop routing engine built upon the disclosed broadcast MACs may allow a plurality of network nodes to discover all their neighboring nodes automatically and to organize themselves reliably into a communications network. When a network element is relocated or when one or more connections or paths fail, the disclosed routing engine can rapidly reorganize the network topology and restore the network connectivity between communicating peers.

To minimize mutual interference in the shared-use bands, ad hoc networks must generally perform adaptive channel selection. One aspect of this invention allows dynamic channel selection even during the transmission of broadcast packets.

This summary does not purport to define the invention. The invention is defined by the claims.

### BRIEF DESCRIPTION OF THE DRAWINGS

FIG. 1 illustrates the layering of one embodiment of a multi-hop routing engine according to the present invention;

FIG. 2 illustrates a format for a packet according to an embodiment of a MAC protocol according to the present invention;

FIG. 3 illustrates a scanning process for a channel according to an embodiment of the present invention;

FIG. 4 illustrates the handshake and data transmission in a broadcast and unicast mode using a MAC protocol according to an embodiment of the present invention;

FIG. 5 illustrates a solution to the “hidden node” problem according to an embodiment of the present invention;

FIG. 6 illustrates the topology discovery process through root synchronization according to an embodiment of the present invention;

FIG. 7 illustrates the topology discovery process through route learning according to an embodiment of the present invention; and

FIG. 8 illustrates an exemplary entry in a routing table at a node in a network according to an embodiment of the present invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

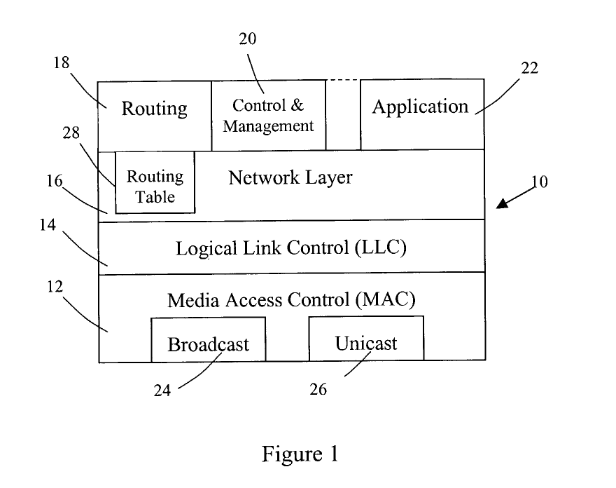

FIG. 1 illustrates an embodiment of a layering of a protocol stack 10 for a multi-hop routing engine for use in an ad hoc network. The protocol stack 10 consists of a Media Access Control (MAC) sublayer 12, a Logical Link Control (LLC) sublayer 14, a Network layer 16, and higher layers that include the Routing 18, the Control and Management 20, and one or more Application protocols 22. The MAC sublayer 12 interfaces directly with the network media and includes modules for multi-channel broadcast 24 and unicast 26 communications.

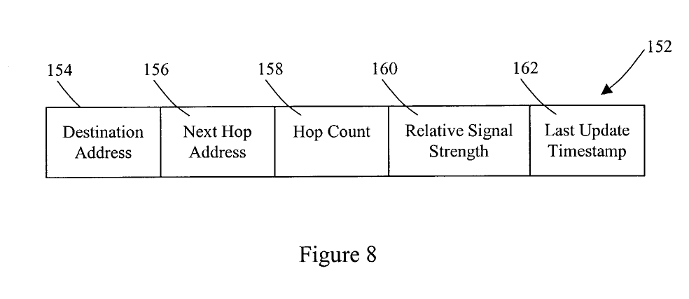

The Network layer 16 performs multi-hop routing to provide the functional and procedural means of transferring variable length data sequences, for example, from a source to a destination. The Network layer 16 is provided with a routing table 28 for facilitating the routing of packets. The structure of the routing table 28 is described in detail below with reference to FIG. 8.

The Routing module 18 may establish and maintain the topology and routing information. In this regard, the routing module 18 may be responsible for updating the topology and routing information on, for example, a predetermined periodic or an as needed basis.

The Control and Management module 20 may provide error reporting for remote maintenance, diagnosis, and administration. The Application protocol module may be a user or machine process that makes use of the reliable multi-hop routing engine to provide communications among the nodes in a wireless network.

The Media Access Control (MAC) sublayer 12 includes two communication modules, a broadcast module 24 and a unicast module 26, the functions of each of which are described below in further detail.

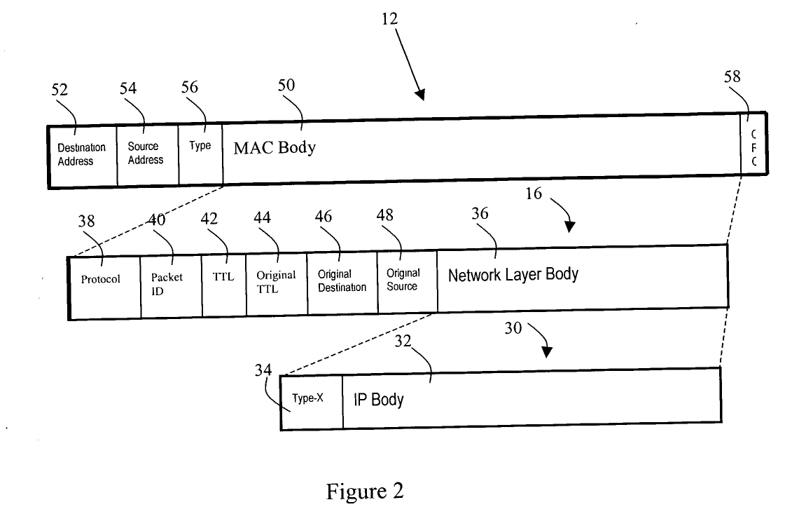

FIG. 2 illustrates the formats of packets for the MAC sublayer 12 and the Network layer 16, with Internet IP packets 30 encapsulated for transport of an open protocol. The Internet IP packet 30 includes an IP packet body 32, which includes the data to be delivered and a Type-X block 34. The Type-X block 34 is a client-supplied 802 packet type. The protocol family type is a standard field that appears in every IEEE 802 packet. In one embodiment, a 0×820 (an unassigned IEEE 802 packet type) may be used.

The Internet IP packet 30 is encapsulated in a Network Layer Body 36 of the Network layer 16. The Network Layer Body 36 contains the protocol transport information. In addition to the Network Layer Body 36, the Network layer 16 includes a Protocol block 38. The entry in the Protocol block 38 is one of the pre-assigned protocol numbers. For example, 0×01 is for Routing protocol, 0×03 is for the 802 envelope, 0×04-0x0F are reserved for system protocols, and 0x10-0xFF are for application protocols.

The Network layer 16 also includes a Packet ID 40, which may be a natural integer, to identify a packet. The Packet ID 40, together with an Original Source Address 48 included in the Network layer 16, produces a unique transmission ID that is used to suppress duplicate broadcasts. Applications may also use this field to suppress duplicate transmissions.

A Time-To-Live (TTL) counter 42 and an Original TTL 44 are also included in the Network layer 16. The TTL counter 42 starts at some well-known value that may be set according to the size of the network, for example, and is decremented every time a node forwards the packet to another node. After repeated forwards, the TTL counter 42 may reach zero before reaching its intended destination. In this case, the Network layer 16 discards the frame, and the Control and Management 20 (shown in FIG. 1) transmits an error packet to the Original Source Address 48. This discarding prevents “lost” packets from endlessly floating in the network.

The Original TTL 44 is the Original Time-To-Live counter. The Original TTL 44 describes the initial value of the TTL 42 field. The Original TTL 44 and the TTL 42 are noted by the Routing module 18 (shown in FIG. 1) in each node to learn paths by observing the difference between the two values as a packets is forwarded.

The Original Destination Address 46 and the Original Source Address 48 are supplied by the client and represent the end-to-end addresses. In one embodiment, these addresses follow IEEE addressing conventions, such as Organizationally Unique Identifiers (OUI).

The Network layer 16 is embedded in a MAC body portion 50 of the MAC layer 12. In addition to the MAC body portion 50, the MAC layer 12 also includes a destination address 52 and a source address 54 for the present hop. These addresses 52, 54 are not necessarily the same as the Original Destination 46 and Original Source 48 addresses in the Network Layer. In fact, except for a single hop transmission, the two sets should never be identical.

The source address 54 is the sender's address for this hop (local) and follows IEEE conventions. The source address 54 should not be a broadcast address because of the danger of creating a broadcast storm.

The MAC layer 12 also includes a Type field 56.

The MAC body portion 50 is followed by a CRC field 58. The CRC field 58 contains a cyclic redundancy check code for data error detection.

In a multi-hop network, the original client may simply fill in an Original Destination address 44 and Original Source address 48, and the Type field 56 for the packet. The Network layer 16 will fill in the rest of the packet. In this arrangement, the addresses are typically 48-bit IEEE 802 compatible MAC identifiers, or OUI's.

In normal operation, the various nodes of a network may follow a priority-driven algorithm that consists of three steps. The first step may be to scan a set of channels to detect potential transmissions. The second step (if the scan detected a message) is to receive a message. The third step is to attempt to transmit a message if one exists. Whenever a node finishes transmitting or receiving it always returns immediately to the channel scanning state.

Potential transmitters play a repeating “Request to Send” (RTS) message header on a channel to indicate a desire to transmit. Scanning nodes first poll a series of m fixed, well-known channel numbers which are preferably spread evenly throughout a communications band. Then the scanning nodes poll a second series of n channels that are also spread throughout the communications band but they are not well-known and depend upon a function of the scanning node's unique identification number (e.g. an OUI or 48-bit IEEE 802 MAC ID.)

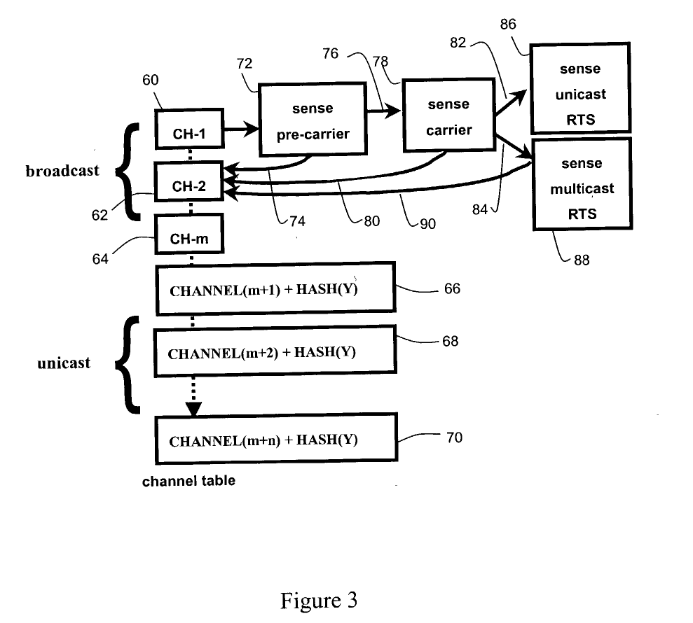

FIG. 3 illustrates the process by which the MAC scans for a channel at a node using a channel-polling algorithm. According to an embodiment of the channel-polling method, available channels are first prioritized. In one embodiment, one or more broadcast channels are first prioritized, followed by a one or more unicast channels. Using this priority polling algorithm, a node may poll the broadcast channel CH-1 60, channel CH-2 62, . . . channel CH-M 64 with priorities 1, 2, . . . m, where m is an integer which is preferably much less than the total number of channels available. In one embodiment, m is three. The node may then poll available unicast channels 66, 68, 70 with lower priority (m+1, m+2, . . . m+n), where n is an integer much less than the total number of available channels. In one embodiment, n is four.

In this arrangement, m fixed broadcast channels are used to allow frequency diversity. To implement broadcast, a node X first determines that no node has a broadcast channel, and then it masters a broadcast channel and places a repeating message on the channel. This message consists of the node's unique identification and an RTS message header. As slaves lock onto the master node X, if a slave node Y sees the RTS, it turns on its transmitter and sends a Clear to Send (CTS) message, completing a CSMA/CA transaction. When the master sees the CTS message it converts its RTS message into a RTS Extension (RTSX) message. This message has not appeared in previous systems. When this conversion occurs, the transmitting slave becomes the “primary slave.” Other slaves that arrive later are referred to as “secondary slaves.” If this confirmation does not come within a given timeframe (e.g., 10 ms), the broadcaster node X assumes that there is either a master collision, slave collision, or interference. Subsequently, node X stops the current attempt and hops to another broadcast channel to begin another attempt.

In one embodiment, the communications channel is TDMA multiplexed, thereby both the master and slave nodes can transmit in alternating time slots. An RTS or CTS message fits in exactly one slot, although this is not a requirement.

Next, the polling algorithm may set out to select a particular channel for communication. A node wishing to communicate may poll the first broadcast channel, CH-1 60, to determine the relative signal strength, for example, by sensing the pre-carrier on the channel (block 72). This is generally performed by the receiver component of the node. If the signal strength is unsatisfactory, broadcast channel CH-I is skipped (line 74), and scanning is advanced to broadcast channel CH-2 62.

If the signal strength at block 72 is satisfactory, as indicated by line 76, the process continues to determine if a lock can be achieved by sensing the carrier (block 78) on channel CH-1 60. If a lock cannot be achieved, channel CH-1 is skipped (line 80), and scanning is advanced to channel CH-2 62.

If a lock is achieved at block 78, as indicated by lines 82 and 84, the process senses whether there are any unicast RTS messages (block 86) or multicast RTS messages (block 88) on channel CH-1 60. If neither exists, channel CH-1 60 is determined to be free, and the node can proceed with its broadcast channel setup. Otherwise, the scanning proceeds to channel CH-2 62.

If for any reason, channel CH-1 60 is determined to be unavailable, the entire process is repeated at channel CH-2. The process continues to each successive lower prioritized channel until a satisfactory channel is found. If all M broadcast channels have been exhausted without finding a satisfactory channel, the broadcast packet is discarded.

A node X wishing to send a unicast message to node Y calculates a hash function, HASH(Y, I), using Y's OUI and 1=0, 1, . . . , n−1, for example, to determine which of the several (e.g., n) unicast channels to use. Node X then performs channel-sensing on channel HASH(Y, 0). If the channel is clear, node X sends out the desired “Request To Send” signal, (RTS, X), and waits for an acknowledgement by way of a “Clear to Receive” signal (CTS, X). If there is no CTS within a timeout period, a reception SCAN is performed. The reception scan includes scanning the channels for possible signal reception. If the reception SCAN fails, then node X performs channel sensing on channel HASH(Y,I), and so forth. In this way, peer-to-peer communications can occur in parallel in the network.

As an example, a chip, such as a cordless phone chip, can support 54 channels with n equal to four. In this example, a number between 0 and 12 is generated by hashing the OUI of node Y, and this is added to CHANNEL(I)=0, 14, 27, or 41 to obtain a destination channel HASH(Y, I)=HASH(Y)+CHANNEL(I). For the initial attempt, node X masters channel HASH(Y, 0) sending out the desired (RTS, X), and waits for acknowledgement (CTS, X). If there is no CTS after a timeout period, the transmitter tries other channels until a (CTS, X) is received by the master node. Once the CTS is received, the master node can then proceed with the unicast operation by sending one or a sequence of data packets.

The multi-channel broadcast MAC provides load balancing for unicast messages in the network. For example, whenever node A wants to transmit to node B, and node C wants to transmit to node D, a hash function is applied to the destination addresses to determine a set of channels to use. There will be no interference if Hash(B,i)!=Hash(D,j). In one embodiment, there are 13 hash equivalency classes. Thus, a conflict only occurs if i=j and HASH(B)=HASH(D). This technique makes it possible for a peer-to-peer network to, for example, carry up to 13 times more data because different pairs of nodes will use separate channels for unicast communications and results in a reduced probability of interference.

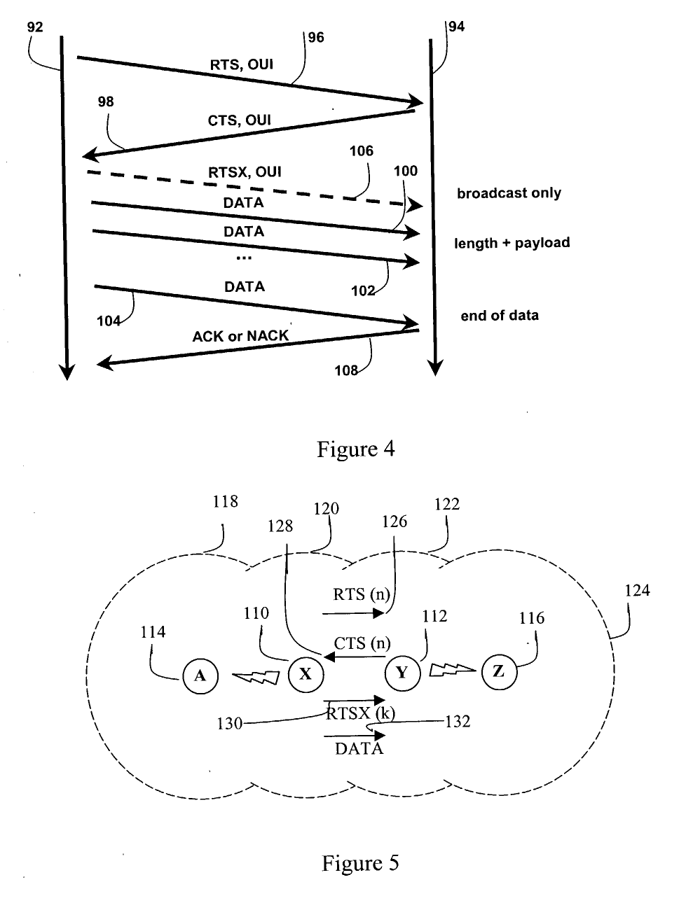

As shown in FIG. 4, a master node 92 and a slave node 94 exchange a sequence of messages successfully before the payload data transmission can take place. To initiate a broadcast or unicast operation, a node X 92 first determines that no node has a broadcast channel, and then it masters a broadcast channel and places a repeating message on the channel. This message consists of node X's OUI and an RTS message header 96. When a slave node Y 94 sees the RTS 96, it turns on its transmitter and sends a CTS 98. If this confirmation does not reach node X 92 within a given timeframe (e.g., 10 ms), then the broadcaster node X assumes that there is a slave collision or interference, and node X hops to another broadcast channel to repeat the attempt.

Once an RTS/CTS handshake (96, 98) has successfully occurred, a unicast data transmission sender can proceed with the operation by sending one or more DATA packets 100, 102, 104 on a unicast channel. For broadcast operation, successful reception of a CTS 98 causes the broadcaster node X 92 to change its message on the broadcast channel to an RTSX message 106.

For broadcast operation, after sending the RTSX message 106, the broadcaster waits for a certain amount of time for other channel-hopping nodes to find the RTSX channel and lock on. Once the RTSX message 106 occurs, additional nodes may detect the RTSX message 106 and settle on the broadcast channel. In certain embodiments, these secondary slave nodes may also turn on their transmitter to produce a spatial reservation for their geographic area. In this regard, all slave nodes may radiate RF power in the same band or time slot using the same PN codes to accomplish this reservation. Because all slaves turn on their transmitters, hidden nodes are able to detect and avoid the reserved broadcast channel.

Finally, after a period of time, the broadcaster node X sends a data packet or a sequence of data packets 100, 102, 104. The time period may be predetermined and may be based on the relative distance between the nodes or the size of the network. The primary slave node Y 94 receives the data packets and verifies a checksum and returns either an acknowledgement (ACK) or a negative-acknowledgement (NACK) message 108 to indicate where or not the correct message was received. At the same time the secondary slaves turn off their transmitters so that the primary slave may send an acknowledgement (ACK) message (not shown).

In one embodiment, the RTSX message 106 may contain a repeating countdown timer that indicates how long to wait before the data packets 100, 102, 104 begin to arrive. In this embodiment, the secondary slaves may turn off their transmitters at the right time, even if they are temporarily unable to hear the transition from the RTSX message 106 to data packets 100, 102, 104. This prevents the secondary slaves from inadvertently jamming the acknowledgement from the primary slave node Y.

In another embodiment, the secondary slave nodes may not turn on their transmitters in order to avoid disturbing the locking algorithm between the primary slave node Y 94 and the master node X 92.

To solve the hidden node problem for broadcast in a system with multiple channels, an RTS/CTS transaction using the carrier alone can be performed. As a requirement, all nodes in the network must have an ability to transmit a constant carrier. In this arrangement, a new node that has just hopped onto a channel that has the RTS or CTS carrier signals can immediately defer until the communications is finished. This mechanism is effective even in scenarios in which newly arriving nodes can only sense the presence of the slaves such as node Y.

FIG. 5 illustrates one embodiment of a solution to the hidden node problem in a broadcast wireless network. In this illustration, pairs of nodes, such as node X 110 and node Y 112, node A 114 and X 110, and node Y 112 and Z 116, are within each other's radio transmission and reception range. The contours of the radio ranges of nodes A 114, X 110, Y 112 and Z 116 are illustrated as dotted lines and designated by reference numerals 118, 120, 122 and 124, respectively.

To initiates a transmission operation, node X 110 may first determine that no node has a broadcast channel. This determination may include failure to detect a broadcast. Node X 110 then masters a broadcast channel and places a repeating RTS message 126 that repeats for a predetermined number of periods. When node Y 112, being in node X's range, detects the RTS message 126, it turns on its transmitter and sends a CTS message 128 for a predetermined number of periods to complete a handshake. Once the handshake has occurred, unicast data transmission can proceed immediately. For broadcast mode, node X 110 changes the RTS message 126 on the broadcast channel to an RTSX message 130 and repeats it for a predetermined number of periods. As described above with respect to FIG. 4, it then waits for a certain amount of time for other channel-hopping nodes to find the RTSX channel and lock on before starting transmission of data packets 132.

When node A 114 finds the RTSX channel and locks onto node X 110, node X 110, node Y 112, and node A 114 are all generating RF signals in their respective geographic regions. The presence of RTS, CTS, or RTSX messages causes node A 114 and other nodes to avoid transmission. Because these carrier signals are generated quasi-continuously, if node Z 116, for example, is channel hopping, it will also avoid transmitting data when it arrives at the channel used by nodes X 110 and Y 112. This therefore solves the hidden node problem for broadcast.

In one embodiment, two forms of link sensing may be used to implement the solution to the hidden node problem: Relative Signal Strength Indicator (the electromagnetic field strength detected by the radio) and Link Quality (a number generated by the radio that describes how many bits are corrected within 64 bit payload, for example).

By solving the hidden node problem, broadcast transmissions may give the same guarantees as unicast transmissions, that at least one node received the packet successfully. This may be important in a network with dynamic routing, because broadcast messages are the backbone of any self-organizing routing system.

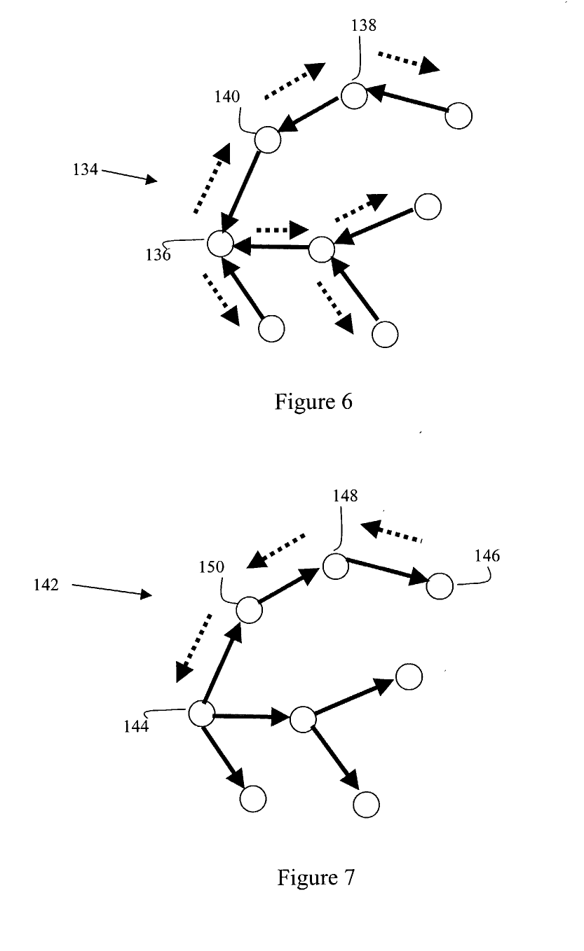

One critical aspect of an ad hoc network as described above is the network's ability to self-organize. In this regard FIGS. 6 and 7 illustrate processes by which each node in the network facilitates this self-organization.

FIG. 6 illustrates the topology discovery process for an individual node through root synchronization. FIG. 6 illustrates a network 134 having a plurality of nodes connected by pathways. In this configuration, a single node 136 may function as a root node and may periodically broadcast a root synchronization packet to all nodes. Any node in the network may take on the role of the root node. The dotted arrows in FIG. 6 indicate the broadcast packet being forwarded along to reach each node in the network. In this regard, each node forwards the packet to all other nodes with which it can communicate. When a downstream node, such as node 138, in the network first receives a root synchronization packet, it determines if the packet is a duplicate by examining its packet identifier 40 and Original Source address 48 (as illustrated in FIG. 2). Duplicate packets may result from a node receiving the same packet through multiple paths, with one packet arriving before the other. In this regard, the first packet to arrive is the one to be used for root synchronization since it is indicative of the most efficient path. Later-arriving, duplicate packets are discarded. Alternatively, the packet with the highest Time-To-Live (TTL) value may be used, while packets with lower TTL values may be discarded since a higher TTL indicates fewer hops between nodes.

For a new, non-duplicate broadcast, the node 138 recognizes the “Original Source Address” in the packet as the address of the root node 136. On the other hand, the “Source Address” indicates the immediately previous node in the path, node 140, and, therefore, the preferred route to the root node 136. The Routing module at the node 138 stores the “Original Source Address” of the packet into the “Destination Address” field of a routing table entry, an example of which is described below with reference to FIG. 8. The “Source Address” is stored in the “Next Hop Address” field of the routing table entry. Thus, a route from the node 138 to the root node 136 is stored in the form of a next “local hop” from the node 138 to the node 140 for the routing table entry for the root node 136. The updating and storing of the routing table entry for the root node is updated at each node in the network 134. The solid arrows denote the next hop for each node in the network 134 and stored in the form of a “Next Hop Address” in the routing table entry for the root node at each other node. Thus, similar “local hop” routes are learned at each node.

After updating the routing table entry for the root node 136, each node, including node 138, replaces the “Source Address” entry in the packet with its own address and rebroadcasts the packet. The solid arrows in FIG. 7 thus illustrate an arm of a spanning tree which denotes how a non-root node (e.g., node 138) routes a data packet to the root node 136 or to other non-root nodes in the network 134.

FIG. 7 illustrates the topology discovery and learning process used by nodes in a network according to embodiments of the present invention. In this embodiment, nodes in a network 142 discovers a path to a remote node by observing packets which it forwards from other remote nodes to a root node 144. The example illustrated in FIG. 7 shows a unicast packet being transmitted by a remote node 146 intended for reception by the root node 144. The path for this packet is illustrated by the dotted arrows in FIG. 7 and is relayed through intermediate remote nodes 148, 150. When the root node 144 receives the packet from the intermediate remote node 150, it recognizes the intermediate remote node 150 denoted by the entry in the “Source Address” field in the packet as the main route to the originating remote node 146, as denoted by the entry in the “Original Source Address” field of the packet.

The root node 144 may then update the entry for the remote node 146 in a routing table by storing the entry in the “Original Source Address” field of the packet into the “Destination Address” field, and the entry in the “Source Address” field into the “Next Hop Address” field of the routing table entry. A next “local hop” route from the root node 144 to the remote node 146 is thereby created or updated in the routing table. Similar routing table entries may be created or updated for each remote node in the network 142. Solid arrows in FIG. 7 denote such “local hop” routes for each node in the network. Thus, the solid arrows constitute a spanning tree which denotes how any node in the tree could route data packets to its children in the spanning tree.

The multi-hop routing engine uses the foregoing MAC paradigm for enhanced reliability. In this arrangement, routing of data packets is performed on a hop-by-hop basis. Specifically, a routing table is maintained at each node in a network. Two aspects concerning network topology discovery include Root Synchronization and Route Learning.

Root Synchronization, described above with reference to FIG. 6, may be performed during initialization of the network and periodically thereafter. One or more nodes may be designated as root nodes which may initiate periodic root synchronization operations. A root proxy agent may be implemented at each non-root node in the network. A root node may periodically broadcast a root synchronization packet to all nodes. The root proxy receiving the root synchronization message may then set its clock while correcting for retransmission delay, and then rebroadcast the root synchronization message using its clock to minimize propagation error. If the network topology changes (e.g., a node or a link fails), the topology of the network can be repaired when the next root synchronization packet arrives. Thus, the frequency of the root synchronization transmissions governs the rate of network repair.

Route Learning, described above with reference to FIG. 7, may be performed in real-time as packets are received or forwarded by a node in a network. The Routing layer may perform Route Learning as a node receives and forwards packets. For example, the root node broadcasts root synchronization messages, which are forwarded through the network by intermediate nodes. Each node may learn two routes from each packet. First, it may learn a route to a directly connected neighbor. Second, it may learn the next hop to the root node. Non-root nodes respond with a routing table packet. As the packet travels to the root node, each intermediate node learns a path to the associated nodes that are further from the root.

The Routing layer may not only recognize broadcasts and forward them, it may also perform duplicate suppression so that the network is not flooded with a large number of broadcast packets. Duplicate suppression can be performed using a table of recently forwarded broadcast packets and the best TTL learned to date.

The protocol described above allows a tree-based routing topology to be constructed in response to a single, root-synchronization packet. This tree-based topology minimizes memory consumption in the intermediate nodes. In many applications each node of the wireless network may send and receive packets to the Internet and not to adjacent or non-adjacent nodes. For these applications, a tree-based routing protocol may be necessary and sufficient. On the other hand, if a workstation user roams through the network and wishes to communicate with every node, he may also send root synchronization packets and collect the network topology in a series of response packets. In a third example, a node may need to communicate only with its neighbors which are, for example, two or three hops away. In this case, the node may send root synchronization packets with a limited time to live. Thus, the disclosed protocol provides a tremendous degree of flexibility in a network where each node has a limited memory space for routing tables.

Once the routing table is constructed, it may be used each time a packet is forwarded to determine its next hop or whether it has reached its final destination. Specifically, a node may first determine if the packet has reached its final destination or the TTL value has become zero. If the packet has not reached its final destination and the TTL value is greater than zero, the node may use the entry in the “Original Destination” field of the packet header as a key to search the routing table. If a matching table entry is found, a “Next Hop” field of the matched table entry may be used to modify the packet header. For example, the entry in the “Source” field may be changed to the current node's address, and the TTL field may be decremented by one. The packet may then be transmitted to its next hop en route to the Original Destination node.

As described above, each node in the network preferably maintains a routing table. FIG. 6 illustrates an example of one embodiment of a routing table entry 152. For each remote node that can be reached from a node X, an entry consisting of 5 tuples, for example, may be stored in a table that may be searched via the destination address key. Each 5-tuple set 152 contains a field for the target “Destination Address” 154, a “Next Hop Address” field 156, a “Hop Count” field 158, and a “Relative Signal Strength” field 160. The “Destination Address” field 154 indicates the node for which this routing table entry contains information. Preferably, an entry for each node in the network is maintained in the routing table and categorized by the “Destination Address” field 154. The “Next Hop Address” field 156 contains the address for the next-hop node for a packet intended for the node indicated in the “Destination Address” field 154. The “Hop Count” field 158 contains information relating to the distance to the node designated in the “Destination Address” field 154. This value may be calculated during Root Synchronization and/or Route Learning. The “Relative Signal Strength” field 160 may contain information that may be used to break ties in hop count. This field 160 may indicate the communication quality of the last packet received from the next-hop node designated in the “Next Hop Address” field 156. Finally, each 5-tuple set 152 may contain a “Last Update Timestamp” field 162 for recording the time of the last update or creation of the entry. This field may be used to purge old entries from the routing table.

It will be apparent to those skilled in the art that the disclosed embodiments of the MAC and multi-hop routing networks provide a number of important advantages. At the media access layer, the multi-channel broadcast MAC provides a reliable, load-balanced and high-throughput broadcast. This enhances the reliability of a multi-hop routing network and allows the network to adapt to the changing network topology and RF-reception conditions. At the routing layer, only nodes that need full topology information need to broadcast the root synchronization packets. This keeps routing table sizes to a minimum. Further benefits of the disclosed embodiments of a dynamic routing protocol allow a rapid restoration of connectivity in case of node or path failure.

It will be evident that the benefits of this invention also apply to other type of networks.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

1. A method of selecting an idle communication channel for broadcast by a first node in a network, the network including a plurality of nodes having a transmitter and a receiver, the method comprising:
a) selecting one of a plurality of predetermined channels;
b) detecting, by the receiver of the first node, the presence or absence of a carrier signal on the selected channel;
c) determining whether the selected channel is available for communication between the first node and a second node; and
d) repeating steps a) through c) when the determining step indicates unavailability of the selected channel.

2. The method according to claim 1, wherein the determining includes sensing RF power by the receiver of the first node.

3. A method of selecting an idle communication channel for unicast by a first node for communication with a second node in a network, each node having a transmitter and a receiver, the method comprising:
a) selecting an integer value between one and n, n being a positive integer less than or equal to a number of available unicast channels;
b) selecting one of the available channels based on the selected integer value and a hash value corresponding to the second node;
c) determining whether the selected channel is open for communication between the first node and the second node; and
e) repeating steps a) through c) when the determining step indicates the selected channel is not open.

4. The method according to claim 3, wherein the selecting of the integer value is random to facilitate load balancing.

5. The method according to claim 3, wherein the determining includes sensing RF power by the receiver of the first node.

6. The method according to claim 3, wherein the determining whether the selected channel is open includes performing a reception scan.

7. The method according to claim 6, wherein the reception scan determines whether the selected channel is being used for communication by at least one other node in the network.

8. A method of transmitting data by a first node to a second node in a network, comprising:
a) selecting, according to a prioritization, an available broadcast or unicast channel from a plurality of predetermined channels;
b) performing a broadcast handshake between the first node and the second node;
c) transmitting a “broadcast extension” message for a predetermined length of time if the selected channel is a broadcast channel, the “broadcast extension” message being adapted to alert other nodes in the network of an upcoming transmission;
d) transmitting data packets on the selected channel for receipt by the second node; and
e) receiving an acknowledgement signal from the second node, the acknowledgement signal being either a positive acknowledgement or a negative acknowledgement, the positive acknowledgement being indicative of a successful receipt of data packets by the second node.

9. The method according to claim 8, further comprising:
repeating steps d) and e) if the acknowledgement signal is a negative acknowledgement until the acknowledgement signal is a positive acknowledgement.

10. The method according to claim 8, wherein the broadcast handshake includes:
broadcasting a signal indicative of readiness to transmit data packets from the first node; and
receiving a signal indicative of readiness to receive for the second node.

11. The method according to claim 8, further comprising:
transmitting a carrier signal during at least one of the performing a broadcast handshake, transmitting a “broadcast extension” message, and the transmitting of the data packets.

12. The method according to claim 8, further comprising:
generating a carrier signal by the second node and by other nodes in the network receiving the “broadcast extension” message until a start of the transmitting of data packets, the carrier signal being detectable by all nodes in the network.

13. The method according to claim 8, wherein the transmitting data packets includes:
forming message frames, each frame including at least the identities of an original source node, an original destination node, a local source node, and a local destination node.

14. A method of organizing a network having a plurality of nodes, comprising:
a) broadcasting a synchronization packet from a root node, the packet indicating the root node as the originating node and having a source node field for an address of a source node;
b) receiving the synchronization packet by a non-root node;
c) determining whether the received synchronization packet is a duplicate of a previously received packet;
d) discarding the synchronization packet if step c) determines it is a duplicate;
e) updating, if step c) determines the synchronization packet is not a duplicate, an entry in a routing table at the non-root node to indicate the address in the source node field as the path to the root node;
f) updating the source node field in the synchronization packet to indicate the non-root node as the source node; and
g) re-broadcasting of the synchronization packet by the non-root node.

15. The method according to claim 14, wherein each entry in the routing table includes identities of an original destination node and a corresponding next-hop node.

16. A method of organizing a network having a plurality of nodes, comprising:
a) receiving a packet from a source node at an intermediate node, the packet including an address for the source node, an originating node and a destination node;
b) updating an entry for the originating node in a routing table at the intermediate node to indicate the address of the source node as the path to the originating node;
f) updating the address for source node in the packet to indicate the intermediate node as the source node; and
g) transmitting the packet to another node, the another node being determined according to an entry in the routing table for the destination node.

17. The method according to claim 14, wherein each entry in the routing table includes identities of an original source node and a corresponding next-hop node.
